(19) United States
(12) Patent Application Publication
(10) Pub. No.: US 2007/0086042 A1
(43) Pub. Date: Apr. 19, 2007

(54) Apparatus, system, and method for selecting ordered files for printing

(76) Inventors: James Michael Herold, Greeley, CO (US); Brian William Moroney, Longmont, CO (US); Farzad Mirshah Valad, Longmont, CO (US)

Correspondence Address: KUNZLER & ASSOCIATES, 8 EAST BROADWAY, SUITE 600, SALT LAKE CITY, UT, 84111, US

(21) Appl. No.: 11/253,367

(22) Filed: Oct. 19, 2005

(51) Int. Cl. G06F 3/12

(52) U.S. Cl. 358/1.15

(57) ABSTRACT

An apparatus, system, and method are disclosed for selecting ordered files for printing. A file selection module receives a plurality of file selections from a file selection window of a web-based graphical user interface. The file selection module receives the file selections in a file order that comprises the order each file is selected. A file order display module displays each file selection in the file order. In addition, a print job module creates a print job from the file order.

### BACKGROUND OF THE INVENTION

1. Field of the Invention

This invention relates to selecting files and more particularly relates to selecting ordered files for printing.

2. Description of the Related Art

Documents printed from electronic sources such as word processing document files often comprise a plurality of document files. Each of the files may be printed in a sequential order to create a completed document comprising all the files. For example, a report may include a cover page file, an abstract file, an index file, a plurality of chapter files, a plurality of appendix files, an index file, and biography files. If each file is printed in the order the file appears in the report, the printed report is completed with each file collated to the file's intended position.

Print servers are often used to print documents, particularly long documents comprised of a variety of files. A print server may be connected to a network and to one or more printers. The printer server receives a print job over the network from a user. The print job may specify parameters such as a printer, one or more files, whether the files are printed on one side or both sides of a page, and the number of copies that should be printed. The print server may process and forward the parameters for the print job including the files to be printed to an appropriate printer. In addition, the print server may allow a user to employ a specialized printer such as a high-speed printer capable of rapidly printing numerous copies of a large document or a printer capable of binding documents.

Print servers may receive a print job created using a user interface such as a web-based graphical user interface (“WGUI”). A user may employ the WGUI to enter the parameters of the print job including each file comprising the print job. The user may enter the files by opening a browse window and selecting the file name for each document file to be included in the print job document. The user may also reorder the selected files so that the document files print in proper sequential order.

Unfortunately, selecting and ordering files can be a time consuming process, particularly for documents that comprise large numbers of files. A user may need to repeatedly browse, select, and print each file. Alternatively, the user may select a plurality of files, but then be required to order the selected files or the printed pages.

From the foregoing discussion, it should be apparent that a need exists for an apparatus, system, and method that select files from a WGUI with the files ordered for printing. Beneficially, such an apparatus, system, and method would allow a user to rapidly select and order files simultaneously for submission to a print server, particularly from the WGUI.

### SUMMARY OF THE INVENTION

The present invention has been developed in response to the present state of the art, and in particular, in response to the problems and needs in the art that have not yet been fully solved by currently available ordered file selection methods. Accordingly, the present invention has been developed to provide an apparatus, system, and method for selecting ordered files that overcome many or all of the above-discussed shortcomings in the art.

The apparatus to select ordered files is provided with a logic unit containing a plurality of modules configured to functionally execute the necessary steps of receiving a plurality of file selections in a file order, displaying each file selection in the file order, and creating a print job from the file order. These modules in the described embodiments include a file selection module, a file order display module, and a print job module.

The file selection module receives a plurality of file selections from a file selection window of a WGUI. The WGUI is configured for inputting print jobs for submission to a print server. A user may select the file selections in the file selection window by indicating each file in the order the files are to be printed using an input device such as a mouse, track ball, or keyboard keystrokes. The file selection module retains each file selection in a file order comprising the order the file selection is selected.

The file order display module displays the file order. In one embodiment, the file order display module displays the file order in the file selection window. The displayed file order may comprise the name of each file selection separated by one or more delimiters.

The print job module creates a print job that includes the file order. The file order may be implied by the order in which file selections are chosen by a user. Alternatively, a user may explicitly define the file order. In one embodiment, the print job comprises an identifier for the user who originates the print job, a printer type specification, a printer identifier, a media specification, a copy number specification, and a side specification. The print job may be created and stored in the Job Definition Format (“JDF”) as defined by the International Cooperation for the Integration of Processes in Prepress, Press and Postpress Organization. The print job may also be created as an Extensible Markup Language (“XML”) file. The apparatus allows a user to select a plurality of file selections for printing in the order each associated file is to be printed, reducing the inputs required to select and order files for printing. The order of the file selections for the print job may be represented by the ordered elements of the XML file defining the print job. The XML file may be validated using an XML Schema Definition (XSD) file that defines an ordered sequence that defines the file order for the file selections of the print job.

A system of the present invention is also presented to select ordered files. The system may be embodied in a computer network. In particular, the system, in one embodiment, includes a print server, a WGUI, a file selection module, a file order display module, and a print job module. The system may also include a printer, a tabular display module, and an order modification module.

The print server communicates with one or more clients over a network. A client user may input a print job to the print server using a WGUI. The print server directs the print job to one or more printers in communication with the print server. In addition, the print server may process the print job for a specified printer.

The WGUI inputs the print job for the print server. A user may specify a printer type, a printer, a media type, a number of copies, and one- or two-sided printing for a print job. In addition, the user may select a plurality of files for printing as part of the print job. The file selection module receives the plurality of file selections from a file selection window of the WGUI in a file order. The file order display module displays each file selection in the file order. The print job module creates a print job from the file order.

In one embodiment, the tabular display module renders the file order in a tabular form on the WGUI. The tabular file order may include each file selection and one or more file attributes such as the file type and the date the file was last modified. The user may employ the order modification module to modify the file order of the rendered file selections. The system supports the selection of print job files as a file order of ordered file selections, wherein the files are printed in the selected file order. In addition, the system allows for modification to the file order.

A method of the present invention is also presented for selecting ordered files. The method in the disclosed embodiments substantially includes the steps necessary to carry out the functions presented above with respect to the operation of the described apparatus and system. In one embodiment, the method includes receiving a plurality of file selections as a file order, displaying each file selection in the file order, and creating a print job from the file order.

A file selection module receives a plurality of file selections from a file selection window of a WGUI. The file selection module receives the file selections in a file order that comprises the order each file is selected. A file order display module displays each file selection in the file order. In addition, a print job module creates a first print job from the file order.

In one embodiment, an order storage module stores the file order. A detection module may detect at least one file of the stored file order in a second print job as the second print job is created. In a certain embodiment, a presentation module presents the stored file order to a user. An order selection module may receive the user's file order selection, and order the files of the second print job using the selected file order.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention receives a plurality of file selections as a file order. In addition, the present invention displays the file order and creates a print job that includes the file order. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a printing system in accordance with the present invention;

FIG. 2 is a schematic block diagram illustrating one embodiment of a file order apparatus of the present invention;

FIG. 3 is a drawing illustrating one embodiment of a WGUI of the present invention;

FIGS. 4a-c are drawings illustrating one embodiment of file selection windows of the present invention;

FIG. 5 is a drawing illustrating one embodiment of a WGUI displaying a tabular file order of the present invention;

FIG. 6 is a schematic block diagram illustrating one embodiment of a computer in accordance with the present invention;

FIG. 7 is a schematic flow chart diagram illustrating one embodiment of a file selection method of the present invention;

FIG. 8 is a schematic flow chart diagram illustrating one embodiment of a file order selection method of the present invention; and

FIG. 9 is a schematic block diagram illustrating one embodiment of a print job format of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

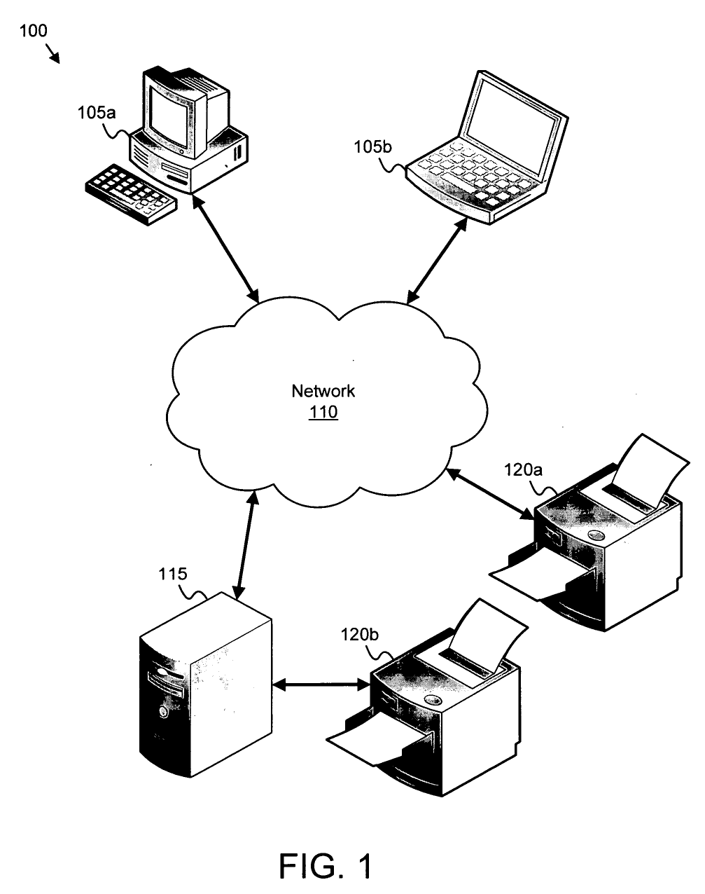

FIG. 1 is a schematic block diagram illustrating one embodiment of a printing system 100 in accordance with the present invention. The system 100 includes one or more clients 105, a network 110, a print server 115, and one or more printers 120.

The client 105 may be a computer workstation, thin-client, laptop computer, personal digital assistant, kiosk, communication router, or cellular telephone. The network 110 may be a local area network, a wide area network, an enterprise network, or the Internet. The client 105 and the print server 115 may communicate with the network 110 through an Ethernet connection, on optical connection, or a wireless connection. The print server 115 communicates with the client 105 over the network 115.

A user of the client 105 may create a print job using a WGUI. The print server 115 may communicate the WGUI to the client 105 as a hypertext markup file (“HTML”), an XML file, or the like. A browser executing on the client 105 may receive the WGUI file and display the WGUI. The user may specify one or more parameters for the print job and select one or more files to be printed using the WGUI. The browser communicates the specified parameters and files to the print server 115.

In one embodiment, the print server 115 creates a print job from the parameters and files received from the WGUI. The print server 115 directs the print job to a printer 120 in communication with the print server 115. In one embodiment, the print server 115 directs the print job to a first printer 120a through the network 110. In an alternate embodiment, the print server 115 directs the print job to a second printer 120b that is in direct communication with the print server 115.

In one embodiment, the print server 115 processes the print job for the printer 120. For example, the print server 115 may execute one or more application programs such as a word processing program or an XML rendering program. The print server 115 may also employ an application program to convert a file into a plurality of print commands. In addition, the print server 115 may execute one or more drivers. Each driver may convert the plurality of print commands into print instructions specific to the printer 120.

In the past, the user may browse a file directory to select each file for the print job. Thus if the user selects three files, the user browses the file directory three times, once for each file. Alternatively, the user may select a plurality of files and order the selected files. The system 100 supports the selection of print job files as ordered files, wherein the files are selected sequentially from a single file selection window and printed in the selected order. In addition, the system allows for modification to the file selection order.

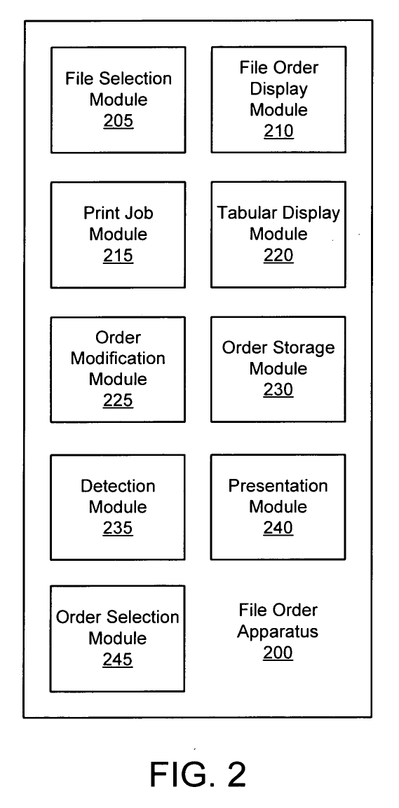

FIG. 2 is a schematic block diagram illustrating one embodiment of a file order apparatus 200 of the present invention. The print server 115 of FIG. 1 may comprise the apparatus 200. In the depicted embodiment, the apparatus 200 includes a file selection module 205, a file order display module 210, a print job module 215, a tabular display module 220, an order modification module 225, an order storage module 230, a detection module 235, a presentation module 240, and an order selection module 245.

In one embodiment, the file selection module 205, file order display module 210, print job module 215, tabular display module 220, order modification module 225, order storage module 230, detection module 235, presentation module 240, and order selection module 245 may be configured as one or more software programs. The software programs may execute on the print server 115. In an alternate embodiment, all or some of the software programs may execute on a client 105 such as the client 105 of FIG. 1.

The print job module 215 may communicate a WGUI to the client 105. In one embodiment, the print job module 215 communicates from the print server 115 through a network 110 such as the network 110 of FIG. 1 with the client 105. A user may employ the WGUI to input print job data. In addition, the print job module 215 may communicate a file selection window to the client 105. The file selection window allows a user to select one or more file selections for a print job. The file selection module 205 receives a plurality of file selections from the file selection window. The file selection window may transmit the file selections to the file selection module 205 in the order the user selects the files. Thus, the file selection module 205 receives the file selections in a file order, wherein the file selections are arranged in the order of selection. In one embodiment, the file selection window transmits the file selections to the print server 115 of FIG. 1. The transmission of the file selection name may indicate selection of the file selection. Alternatively, the file selection window may transmit an array of data fields for each file selection comprising a file name and a data field value that indicates selection. File order may be communicated implicitly by the order of the file selections names in the transmission or array of fields. Alternatively, each file selection may include a file order indicator such as a numeric value.

The file order display module 210 displays the file order of the file selections. In one embodiment, the file order display module 210 displays the file order in the file selection window. The print job module 215 creates a first print job that includes the file selections in the file order. The first print job may be created in a JDF format. The first print job may also be created as an Extensible Markup Language (“XML”) file. In addition, the print job module 215 communicates the first print job to the print server 115.

In one embodiment, the tabular display module 220 renders the file order in a tabular form on the WGUI. For example, each file selection in the file order may be rendered on a separate row of a column of files. Each row may further include one or more file attributes for the file selection, such as the file type and the date the file was last modified.

The user may employ the order modification module 225 to modify the file order of the rendered file selections. For example, the user may select a second file in the file order and modify the second file's position within the file order to the first position. The user may also remove a file selection from the file order or add a file selection to the file order.

In one embodiment, the order storage module 230 stores the file order. The order storage module 230 may store the file order as a linked list of arrays, wherein each array comprises one or more data fields including a data field specifying a file selection within a directory structure. In an alternate embodiment, the order storage module 230 stores the file order in a flat file. The order storage module 230 may write the file order to a non-volatile storage device such as a hard disk drive. In a certain embodiment, the order storage module 230 maintains the file order in the print server's 115 memory.

In one embodiment, the user of the client 105 may input a second print job. The user may further select one or more files to include with the print job. The detection module 235 may detect a file selection in the first print job file order within the second print job file selections as the second print job is created. For example, if the stored file order of the first print job included the file selection “chapter1.PDF,” the detection module 235 detects the file selection “chapter1.PDF” as an instance of a file selection in the first print job file order.

In a certain embodiment, a presentation module 240 presents the stored file order of the first print job to the user in response to the detected instance of the stored file order. For example, the presentation module 240 may present one or more stored file orders wherein each stored file order comprises one or more files selected by the user for the second print job. The user may select a stored file order as presented by the presentation module 240. The order selection module 245 may receive the user's file order selection and order the file selections of the second print job using the selected file order. For example, the order selection module 245 may duplicate the stored file order as the file order for the second print job.

The apparatus 200 allows a user to select a plurality of files for printing wherein the order of each file is retained in a file order, reducing the inputs required to select and order files for printing. The apparatus 200 may further allow the user to reuse a file order for a subsequent print job.

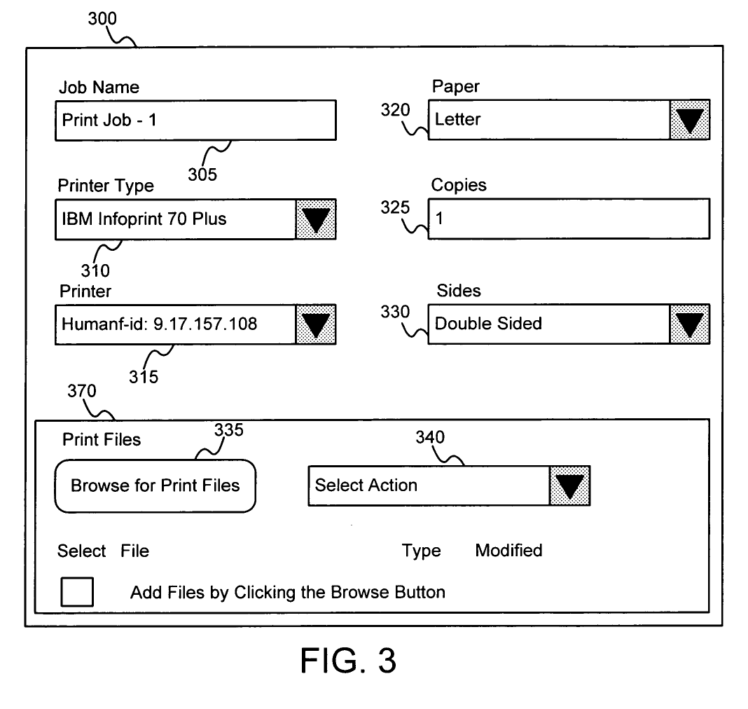

FIG. 3 is a drawing illustrating one embodiment of a WGUI 300 of the present invention. The WGUI 300 may be rendered by the browser of a client 105 such as the client 105 of FIG. 1 from an interface file such as an HTML file. A print server 115 such as the print server 115 of FIG. 1 may transmit the interface file to client 105.

The WGUI 300 allows a user to define print jobs for the print server 115. As depicted, the WGUI 300 includes a job name field 305, a printer type field 310, a printer field 315, a media field 320, a copies field 325, a sides field 330, and a print files box 370. The print files box 370 includes a browse button 335 and an action field 340. A user may enter a print job name in the job name field 305. The user may also specify a printer type in the printer type field 310. For example, the user may specify a color printer. In the depicted embodiment, the user selects the IBM infoprint 70 plus printer manufactured by International Business Machines Corporation (“IBM”) of Armonk, N.Y. In one embodiment, the printer type field 310 is configured to present the user with one or more printer type options. For example, the printer type field 310 may be configured with a pull-down menu that lists each available printer type on a printing system 100 such as the printing system 100 of FIG. 1. The user may specify the printer type by selecting an available printer type from the pull-down menu.

The user may further specify a printer 120 such as the printer 120 of FIG. 1 in the printer field 315. In one embodiment, the printer field 315 is configured to present one or more printer 120 options to the user as a menu. For example, the printer field 315 may be configured with a pull-down menu that lists each printer 120 of the printer type specified in the printer type field 310 that is available on the printing system 100. The user may specify the printer 120 by selecting the available printer 120 from the pull-down menu.

In one embodiment, the user specifies a media type in the media field 320. The media type may include the size of paper, the weight of paper, the color of paper, perforations, transparencies, cover material, or the like. The media field 320 may be configured to present one or more media options to the user. For example, the media field 320 may include a menu such as a drop-down menu comprising each type of media that is available for the printer 120 specified in the printer field 315. In an alternate embodiment, the user may first select a media type in the media type field 320. Responsive to the media type selection, the printer field 315 may be configured to display each available printer 120 that includes media of the selected media type.

The user may specify a number of copies to be printed in the copies field 325. For example, the user may enter the number twelve (12) to specify that twelve (12) copies of a document be printed. The user may further specify whether the printer 120 prints on one side or two sides of the media using the sides field 330. For example, the user may specify that the document be printed on both sides of each printed page by entering “Double Sided” in the sides field 330.

In one embodiment, the sides field 330 is configured with a menu such as a radio-button menu displaying one or more options. For example, the sides field 330 radio-button menu may list the sides options for the printer 120 specified in the printer field 315. The user may select a sides option from the sides field radio-button menu. In an alternate embodiment, the user may first specify double-sided printing using the sides field 330. The printer field 315 may subsequently display a menu comprising one or more printers 120 configured for double-sided printing.

The user may select one or more files for printing using the browse button 335. In one embodiment, selecting the browse button 335 may cause a file selection window to be displayed. The browse button 335 and all buttons and options described herein may be selected using a pointing device including but not limited to a computer mouse, a track ball, a pen input, or a touch screen as is well known to those skilled in the art. The WGUI 300 allows a user to input parameters of a print job for communication to the print server 115.

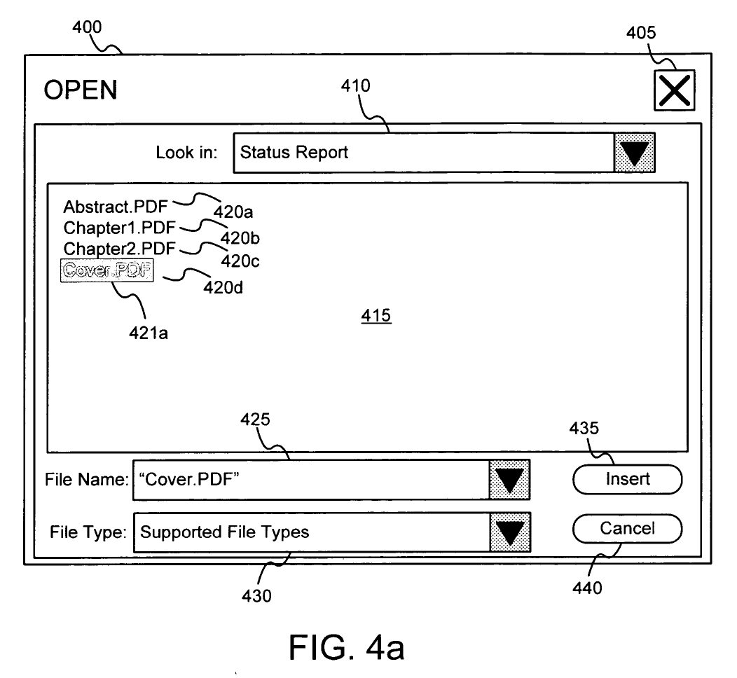

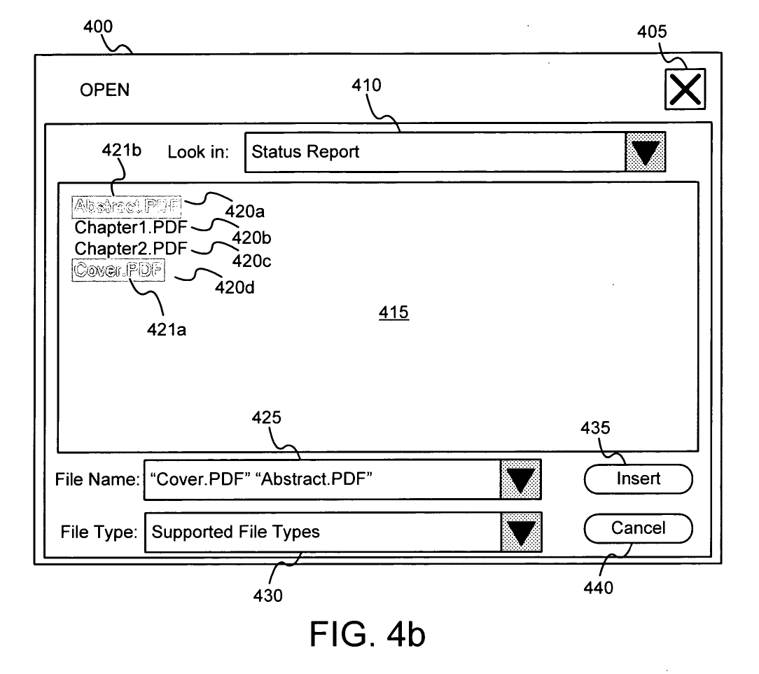

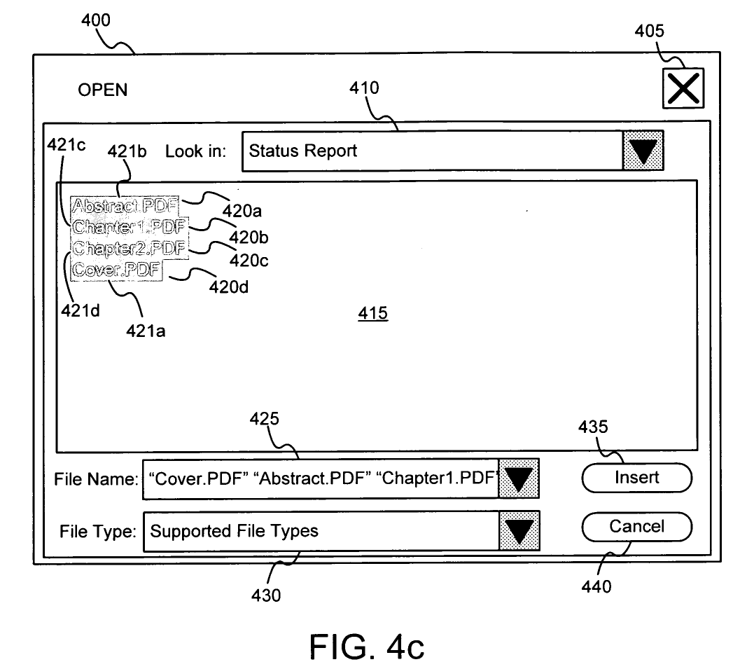

FIG. 4a illustrates one embodiment of a file selection window 400 of the present invention. In one embodiment, the file selection window 400 is displayed in response to the selection of the browse button 335 of FIG. 3. As depicted, the file selection window 400 includes a close button 405, a directory selection field 410, a file list field 415, a file selection field 425, a file type field 430, an insert button 435, and a cancel button 440. The file list field 415 may further comprise the names of one or more files 420 located in the directory specified by the directory selection field 410. The file selection window 400 is configured to select one or more files for inclusion in a print job such as the print job created using the WGUI 300 of FIG. 3.

In one embodiment, selecting the close button 405 closes the file selection window 400. A user may employ the directory selection field 410 to navigate to a directory within a file structure, including the file structure of a client 105 such as the client 105 of FIG. 1. For example, the user may navigate to one or more directories within the file structure wherein each directory may comprise one or more files 420 for inclusion in the print job. Upon navigating to a directory, the file list field 415 displays files 420 within the directory. In one embodiment, the user may select a specified file type using the file type field 430. If a file type is specified in the file type field 430, the file list field 415 only displays files 420 of the specified type in the file list field 415.

In the depicted embodiment, the user designates a “Cover.PDF” file 420d as a file selection 421a. The user may designate or select the file 420d using a pointing device such as a computer mouse, track ball, pen input, or touch screen. In an alternate embodiment, the user may select the file 420 using a keyboard. The file selection 421a may be indicated by a highlighted box around the file name 420d. A file selection module 205 such as the file selection module 205 of FIG. 2 receives the selected file selection 421a from the file selection window 400 as a first element in a file order. A file order display module 210 such as the file order display module 210 of FIG. 2 displays the file order in the file selection field 425, indicating the file selection 421a and the current file order.

FIG. 4b illustrates one subsequent embodiment of the file selection window 400 of FIG. 4a. The user selects an “Abstract.PDF” file selection 421b in the file list field 415. The file selection module 205 receives the selected “Abstract.PDF” file 420a as a second element in the file order, appending the “Abstract.PDF” file 420a name to the file order. The file list field 415 highlights the selected “Abstract.PDF” file 420a name. In addition, the file order display module 210 displays the appended file order in the file selection field 425. Because the “Abstract.PDF” file selection 421b is selected subsequent to the “Cover.PDF” file selection 421a, the “Abstract.PDF” file selection 421b name is listed after the “Cover.PDF” file selection 421a to indicate the file order of the files selections 421a, 421b. In the depicted embodiment, the selected “Abstract.PDF” file selection 421b and “Cover.PDF” file selection 421a are separated by delimiters including quotes around each file selection 421 and a space between each file 420 name. The files selections 421a, 421b may also be displayed in a tabular column or delimited by one or more delimiters that may include letters, punctuation, and symbols.

FIG. 4c is drawing illustrating one subsequent embodiment of the file selection window 400 of FIG. 4c. The user selects a “Chapter1.PDF” file selection 421c and a “Chapter2.PDF” file selection 421d in the file list field 415. The file selection module 205 receives the selected “Chapter1.PDF” file selection 421c and “Chapter2.PDF” file selection 421d as a third element and fourth element respectively in the file order, appending the “Chapter1.PDF” file selection 421c and “Chapter2.PDF” file selection 421d to the file order. The file list field 415 highlights the selected “Chapter1.PDF” file selection 421c and “Chapter2.PDF” file selection 421d. In addition, the file order display module 210 displays the appended file order in the file selection field 425. In the depicted embodiment, the “Chapter2.PDF” file selection 421d is not visible, although the “Chapter2.PDF” file selection 421d may be displayed by scrolling the file selection field 425.

The user may complete the selection of file selections 421 by selecting the insert button 435. In addition, the user may also cancel the selection of file selections 421 by selecting the cancel button 440. In one embodiment, selecting the cancel button 440 deletes the file order from the file selection module 205.

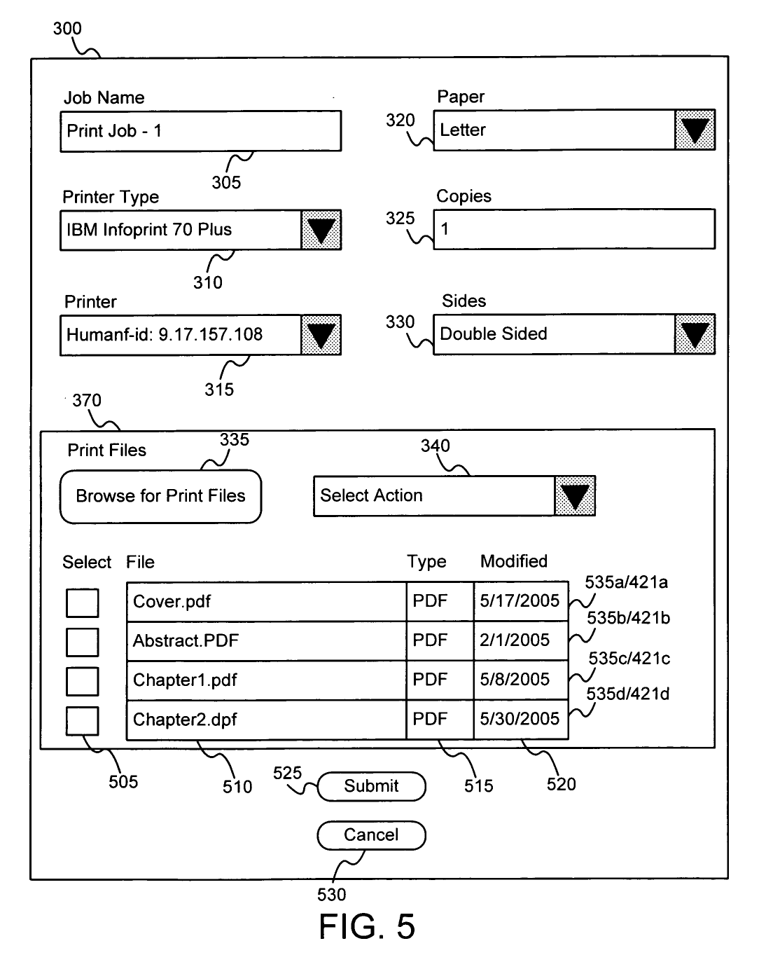

FIG. 5 is a drawing illustrating one embodiment of a WGUI 300 displaying a tabular file order of the present invention. The WGUI 300 depicts the WGUI 300 of FIG. 3 subsequent to the selection of files selections 421 using the file selection window 400 of FIGS. 4a-c. In one embodiment, a tabular display module 220 such as the tabular display module 220 of FIG. 2 renders the file order in a tabular form in the print files box 370 on the WGUI 300. As depicted, the print files box 370 displays each file selection 421 in a tabular row 535. Each tabular row 535 includes a file name 510, a file type 515, and a last modified date 520. Each tabular row 535 may also include a select button 505.

In one embodiment, the user selects a file selection 421 by selecting the file selection's 421 tabular row 535 using the select button 505. The selected tabular row 535 may be indicated by a check mark. The user may further select and execute an action on the selected file selection by selecting the action button 340. The action button 340 may be configured as a menu such as a drop-down menu listing one or more action options. Action options include but are not limited to moving the position of the selected file 420 within the file order and removing the selected file 420 from the file order. The file order is represented by the order of the file selections 421a-d in the rows 535a-d starting with the top row 535a and proceeding to the bottom row 535d. In one example, the user may select a second tabular row 535b and select a “move up” action using the action button 340. An order modification module 225 such as the order modification module 225 of FIG. 2 may modify the file order by moving the “Abstract.PDF” file selection 421b of the second tabular row 535b to the first element position with the file order. In addition, the tabular display module 220 may render the modified file order.

An order storage module 230 such as the order storage module 230 of FIG. 2 may store the file order. The order storage module 230 may store the file order as an ordered flat file associated with the user. For example, the order storage module 230 may store the file order file in a directory that is identified by a user network identifier with the directory associated with a plurality of file order directories. The stored file order may subsequently be reused as the basis for one or more print jobs, reducing the file selections 421 required to define a future print job. In one embodiment, the user may submit the print job by selecting the submit button 525. A print job module 215 such as the print job module 215 of FIG. 2 may create the print job in response to the selection of the submit button 525. The user may also cancel the print job by selecting the cancel button 530.

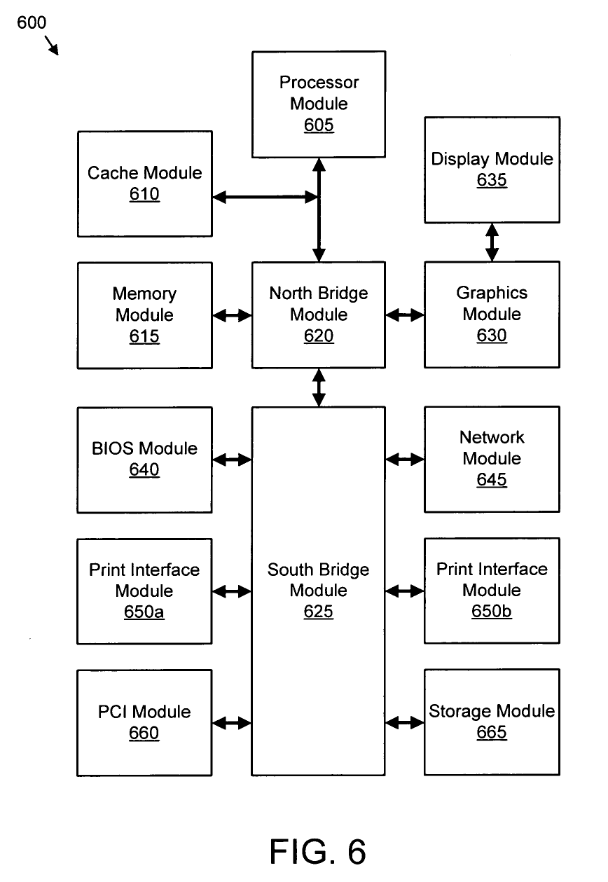

FIG. 6 is a schematic block diagram illustrating one embodiment of a computer 600 in accordance with the present invention. The computer 600 includes a processor module 605, a cache module 610, a memory module 615, a north bridge module 620, a south bridge module 625, a graphics module 630, a display module 635, a basic input/output system (“BIOS”) module 640, a network module 645, one or more print interface modules 650, a peripheral component interconnect (“PCI”) module 660, and a storage module 665. The computer 600 may be the print server 115 of FIG. 1. In addition, the computer 600 may be the client 105 of FIG. 1.

The processor module 605, cache module 610, memory module 615, north bridge module 620, south bridge module 625, graphics module 630, display module 635, BIOS module 640, network module 645, print interface modules 650, PCI module 360, and storage module 665, referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate to substrate wiring, or circuit card traces or wires connecting the semiconductor devices.

The memory module 615 stores software instructions and data. The processor module 605 executes the software instructions and manipulates the data as is well know to those skilled in the art. The processor module 605 may execute and the memory module 615 may store one or more software programs comprising the file selection module 205, file order display module 210, print job module 215, tabular display module 220, order modification module 225, order storage module 230, detection module 235, presentation module 240, and order selection module 245 of FIG. 2.

The processor module 605 may communicate with one or more printers 120 such as the printers 120 of FIG. 1 through the north bridge module 620, the south bridge module 625 and through the network module 645 or the print interface modules 650. The processor module 605 may also communicate with a network 110 such as the network 110 of FIG. 1 through the north bridge module 620, the south bridge module 625 and the network module 645. The network module 645 may be an Ethernet interface, a token ring interface, or the like. The print interface module 650 may be a network interface such as an Ethernet interface, a serial bus interface such as a universal serial bus (“USB”) interface, or the like.

In one embodiment, the processor module 605 communicates a WGUI 300 such as the WGUI 300 of FIGS. 3 and 5 and a file selection window 400 such as the file selection window 400 of FIG. 4 to a client 105 such as the client 105 of FIG. 1. The file selection module 205 executing on the processor module 605 may receive file selections from the file selection window 400 as a file order. The file order display module 210 executing on the processor module 605 of the client 105 may display the file order on the file selection window 400 such as in the file selection field 425 of FIGS. 4a-c. In addition, the print job module 215 executing on the processor module 605 may create a print job from the WGUI 300 parameters and the file order and communicate the print job to the printer 120.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

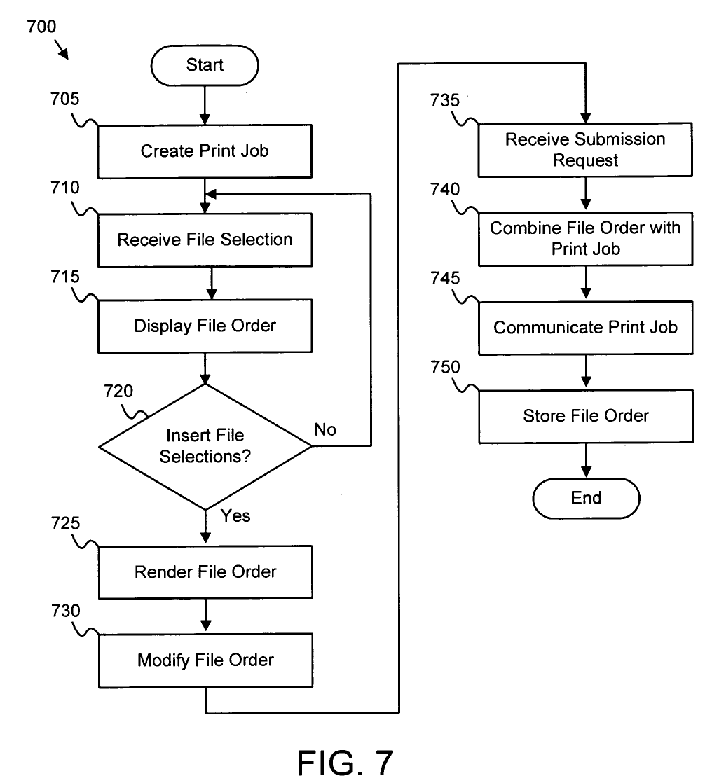

FIG. 7 is a schematic flow chart diagram illustrating one embodiment of a file selection method 700 of the present invention. The method 700 substantially includes the steps necessary to carry out the functions presented above with respect to the operation of the described system 100 and apparatus 200 of FIGS. 1 and 2.

The method 700 begins, and in one embodiment, a print job module 215 such as the print job module 215 of FIG. 2 creates 705 a print job. The print job module 215 may initiate the creation 705 of the print job in response to a user request from a client 105 such as the client 105 of FIG. 1. In addition, the print job module 215 may communicate a WGUI 300 such as the WGUI 300 of FIG. 3 to the client 105. The print job module 215 may also communicate a file selection window 400 such as the file selection window 400 of FIGS. 4a-c to the client 105.

A file selection module 205 such as the file selection module 205 of FIG. 2 receives 710 a plurality of file selections 421 from the file selection window 400. The file selection module 205 receives the file selections 421 as a file order that comprises the order each file selection 421 is selected. A file order display module 210 such as the file order display module 210 of FIG. 2 displays 715 each file selection 421 in the file order. The file order display module 210 may display 715 the file order in a file selection field 425 such as the file selection field 425 of FIGS. 4a-c. In an alternate embodiment, the file order display module 210 displays 715 the file order as a tabular list. The tabular list may be configured as a pop-up window.

In one embodiment, the file selection module 205 determines 720 if the selected files selections 421 may be inserted in the print job. In a certain embodiment, a user of the client 105 selects an insert button 435 such as the insert button 435 of FIGS. 4a-c to indicate to the file selection module 205 that the selected files selections 421 may be inserted.

If the file selection module 205 determines 720 the selected files 420 may not be inserted, the file selection module 205 continues to receive 710 file selections 421. If the file selection module 205 determines 720 the file selections 421 may be inserted, a tabular display module 220 such as the tabular display module 220 of FIG. 2 may render 725 the file order in a tabular form such as is depicted in FIG. 5 by the plurality of tabular rows 535 of the print files box 370.

In one embodiment, an order modification module 225 such as the order modification module 225 of FIG. 2 may modify 730 the file order. The order modification module 225 may modify 730 the file order in response to a user command. For example, the user may direct the order modification module 225 to modify the position of a file selection 421 in the file order by selecting a select button 505 such as the select button of FIG. 5 in a tabular row 535 that includes the file selection's 421 file name 510. The user may further direct the order modification module 225 to modify the position of the file selection 421 by selecting a move command using an action button 340 such as the action button 340 of FIGS. 3 and 5. For example, the user may select the command “MOVE DOWN” and the order modification module 225 may move the file selection 421 to a subsequent position such as the next subsequent position in the file order. In one embodiment, the user may drag and drop the file selection 421 to a new position in the file order as is well know by those skilled in the art.

In one embodiment, the print job module 215 receives 735 a submission request. The user may communicate the submission request by selecting a submit button 525 such as the submit button 525 of FIG. 5. The print job module 215 combines 740 the file order with the print job. In addition, the print job module 215 may include one or more parameters including the specified printer, number of copies, media type, and the sides of the media to be printed to the print job. In one embodiment, the print job module 215 combines 740 the ordered file names of the file selections 421 in the file order with the print job. In an alternate embodiment, the print job module 215 combines 740 the files selections 421 of the file order with the print job.

The print job module 215 communicates 745 the print job to a printer 120 such as the printer 120 of FIG. 1. Alternatively, the print job module 215 communicates 745 the print job to the print server 115 of FIG. 1. In one embodiment, the print job module 215 communicates 745 the print job in a JDF format. In an alternate embodiment, the print job module 215 communicates 745 the print job as an XML file. For example, the print job module 215 may convert each file selection 421 of the print job to an XML format element and concatenate each converted XML rendition into a print job file. The order of the file selections for the print job may be represented by file selection elements of the XML file defining the print job. The XML file may be validated using an XML Schema Definition (XSD) file that defines an ordered sequence for the file order for the file selections of the print job. The print job module 215 may reference the XSD file to valid the XML file and derrive the file order. In a certain embodiment, the print job module 215 processes the files 420 and parameters of the print job and communicates the print job in a format specific to the printer 120.

In one embodiment, an order storage module 230 such as the order storage module 230 of FIG. 2 stores 750 the file order. The order storage module 230 may store 750 the file order in a memory module 615 such as the memory module 615 of FIG. 6. Alternatively, the order storage module 230 may store 750 the file order in a storage module 665 such as the storage module 665 of FIG. 6 and the method 700 terminates. The method 700 supports the selection of file selections 421 for a print job with the file selections 421 ordered in the order of selection, simplifying the selection of ordered files 420 for a print job.

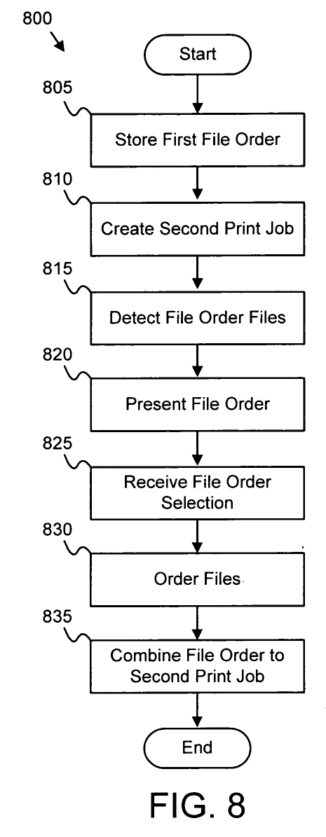

FIG. 8 is a schematic flow chart diagram illustrating one embodiment of a file order selection method 800 of the present invention. The method 800 substantially includes the steps necessary to carry out the functions presented above with respect to the operation of the described system 100 and apparatus 200 of FIGS. 1 and 2.

The method 800 begins and in one embodiment, an order storage module 230 such as the order storage module 230 of FIG. 2 stores 805 a first file order for a first print job such as in the store file order step 750 of FIG. 7. A print job module 215 such as the print job module 215 of FIG. 2 creates 810 a second print job under the direction of a user wherein a file selection module 205 such as the file selection module 205 of FIG. 2 may receive 710 one or more file selections 421 as a file order during the creation of the second print job. A detection module 235 such as the detection module 235 of FIG. 2 may detect 815 at least one file of the stored first file order in the selected files selections 421 for the second print job. In one embodiment, the detection module 235 compares each file selection 421 for the second print job with each file selection 421 stored in the stored first file order and detects the at least one file selection 421 when a file selection 421 and a stored first file order file selection 421 are equivalent. In a certain embodiment, the detection module 235 compares each selected file selection 421 of the second print job with each file selection 421 of each stored file order for the user directing the creation of the second print job.

In one embodiment, a presentation module 240 such as the presentation module 240 of FIG. 2 presents 820 the stored first file order to a user. The stored first file order may be presented as a print job name in a list of stored file orders. The presentation module 240 may also present 820 the stored first file order by displaying the file selections 421 of the first file order. The user may select the first file order, and an order selection module 245 such as the order selection module 245 of FIG. 2 may receive 825 the user's file order selection. The order selection module 245 may further order 830 the file selections 421 of the second print job using the selected first file order. In one embodiment, the print job module 215 combines 835 the file order with the second print job. The method 800 detects the creation of a second print job with a file order similar to a first print job file order and allows the user to select the first print job file order for the second print job. Thus, the method 800 allows the file order of a first print job to serve as a template for the file order of a second print job, speeding the selection of frequently used file selection 421 combinations.

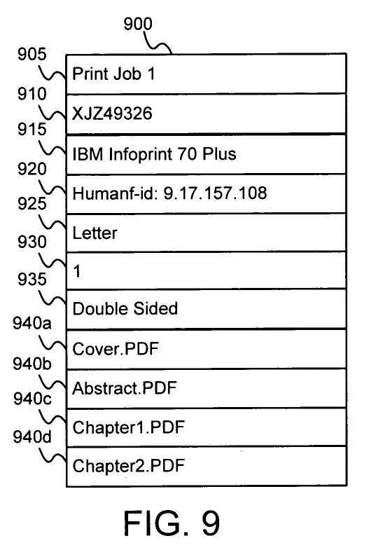

FIG. 9 is a schematic block diagram illustrating one embodiment of a print job format 900 of the present invention. The print job format 900 may comprise the print job that a print job module 215 such as the print job module 215 of FIG. 2 communicates 745 to a printer 120 such as the printer 120 of FIG. 1. The print job format 900 includes a print job name field 905, a print job identifier field 910, a printer type field 915, a printer field 920, a media type field 925, a copies field 930, a sides field 935, and one or more file selection fields 940.

Each field of the print job format 900 may comprise a plurality of digital data words. In one embodiment, each field is a fixed length. One or more fields may also be of a variable length. A print job module 215 such as the print job module 215 of FIG. 2 may generate the data comprising the print job identifier field 910. The print job identifier 910 may comprise an identifier for a client 105 creating the print job such as the client 105 of FIG. 1, a time stamp, a random number, and the like.

In one embodiment, the print job name field 905, the printer type field 915, the print field 920, the media type field 925, the copies field 930, and the sides field 935 include data from the job name field 305, printer type field 310, printer field 315, media field 320, copies field 325, sides field 330 respectively of the WGUI 300 of FIGS. 3 and 5. In a certain embodiment, the print job module 215 may process the data in the fields, converting the data to a format for a specified printer 120.

In one embodiment, the file selection fields 940 comprise the contents of files 420 corresponding to file selections 421 of a file order selected by a user for printing. For example, the print job module 215 may concatenate each file 420 of the file order as a file field 940 in the print job format 900. In an alternate embodiment, the print job module 215 processes each file 420 of the file order. The print job module 215 may convert each file 420 to a printer 120 specific format. In an alternate embodiment, the print job module 215 may convert each file 420 to an XML format. In a certain embodiment, the print job module 215 converts each file 420 to printer 120 specific print instructions. The print job module 215 may further store each converted file 420 in a file field 940 to form a concatenated XML document.

In one embodiment, the print job module 215 writes the name of each file 420 of the file order in a file field 940. The print job module 215 further communicates each file 420 of the file order using the print order format 900.

In one embodiment, an order storage module 230 such as the order storage module 230 of FIG. 2 stores 750 the print job format 900 as the file order. A detection module 235 such as the detection module 235 of FIG. 2 may retrieve the print job format 900 and use the print job format 900 to detect the use of a file selection 421 in the file order comprised by the field files 940 in a second print job.

The present invention receives 710 a plurality of file selections 421 as a file order. In addition, the present invention displays 715 the file order and communicates 745 a print job that includes the file order. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to select ordered files, the apparatus comprising:
a file selection module configured to receive a plurality of file selections from a file selection window of a web-based graphical user interface in a file order comprising the order each file is selected;
a file order display module configured to display each file selection in the file order; and
a print job module configured to create a first print job comprising the file selections ordered in accordance with the file order.

2. The apparatus of claim 1, further comprising a tabular display module configured to render the file order in a tabular form on the web-based graphical user interface.

3. The apparatus of claim 2, further comprising an order modification module configured to modify the file order in response to user input.

4. The apparatus of claim 1, further comprising an order storage module configured to store the file order.

5. The apparatus of claim 4, further comprising a detection module configured to detect at least one file selection associated with the stored file order in a second print job.

6. The apparatus of claim 5, further comprising a presentation module configured to present the stored file order to a user, an order selection module configured to receive a file order selection, and wherein the print job module prints the files of the second print job using the selected file order.

7. A system to select ordered files, the system comprising:
a print server;
a web-based graphical user interface configured to input print jobs for the print server and comprising a file selection window;
a file selection module configured to receive a plurality of file selections from the file selection window in a file order comprising the order each file is selected;
a file order display module configured to display each file selection in the file order; and
a print job module configured to create a print job from the file selections ordered in accordance with the file order.

8. The system of claim 7, further comprising a printer, wherein the print server prints the print job on the printer.

9. The system of claim 7, further comprising a tabular display module configured to render the file order in a tabular form on the web-based graphical user interface.

10. The system of claim 9, further comprising an order modification module configured to modify the file order.

11. The system of claim 7, further comprising an order storage module configured to store the file order.

12. A signal bearing medium tangibly embodying a program of machine-readable instructions executable by a digital processing apparatus to perform operations to select ordered files for printing, the operations comprising:
receiving a plurality of file selections from a file selection window of a web-based graphical user interface in a file order comprising the order each file is selected;
displaying each file selection in the file order; and
creating a first print job from the file selections ordered in accordance with the file order.

13. The signal bearing medium of claim 12, wherein the instructions further comprise an operation to render the file order in a tabular form on the graphical user interface.

14. The signal bearing medium of claim 13, wherein the instructions further comprise an operation to modify the file order.

15. The signal bearing medium of claim 12, wherein the web-based graphical user interface comprises a print server interface.

16. The signal bearing medium of claim 12, wherein print job is created in a job definition format.

17. The signal bearing medium of claim 12, wherein print job is created as an XML file.

18. The signal bearing medium of claim 12, wherein the instructions further comprise an operation to store the file order.

19. The signal bearing medium of claim 18, wherein the instructions further comprise operations to detect at least one file selection of the stored file order in a second print job.

20. The signal bearing medium of claim 19, wherein the instructions further comprise operations to present the stored file order to a user, receive the user's file order selection, and order the file selections of the second print job using the selected file order.
